(19) United States
(12) Patent Application Publication
(10) Pub. No.: US 2024/0425068 A1
(43) Pub. Date: Dec. 26, 2024

(54) DISPLAY CONTROL DEVICE

(71) Applicant: TOYOTA JIDOSHA KABUSHIKI KAISHA, Toyota-shi (JP)

(72) Inventors: Hideharu NOHARA, Toyota-shi (JP); Tatsuroh HATANO, Toyota-shi (JP)

(73) Assignee: TOYOTA JIDOSHA KABUSHIKI KAISHA, Toyota-shi (JP)

(21) Appl. No.: 18/740,474

(22) Filed: Jun. 11, 2024

(30) Foreign Application Priority Data
Jun. 23, 2023 (JP) 2023-103374

(51) Int. Cl. B60W 50/08; B60W 60/00

(52) U.S. Cl. CPC B60W 50/082; B60W 60/005

(57) ABSTRACT

A display control device provided in a vehicle includes a display unit that has an automatic driving mode or a manual driving mode as a driving mode and displays information to an occupant, and the display control device controls the display unit to display a plurality of types of display modes including a first type display mode that displays a state of the vehicle at the time of display and a second type display mode that does not display a state of the vehicle at the time of display, and displays a second type display mode at the time of display when a predetermined first condition is satisfied including that a driving mode is switched from a manual driving mode in which a display according to the first type display mode is performed in the display unit to an automatic driving mode.

### CROSS-REFERENCE TO RELATED APPLICATION

This application claims priority to Japanese Patent Application No. 2023-103374 filed on Jun. 23, 2023, incorporated herein by reference in its entirety.

### BACKGROUND

### 1. Technical Field

The present disclosure relates to a display control device.

### 2. Description of Related Art

In a four-wheel drive vehicle, for example, as described in Japanese Unexamined Patent Application Publication No. 2019-11019 (JP 2019-11019 A), there is a display device with which a state of distribution of a driving force applied to each wheel is able to be visually recognized. The display device informs the driver about the state of the distribution of the driving force. The display device prompts a more appropriate operation by causing the driver to recognize how much driving force can be distributed to each wheel. In the following description, such function of the display device is referred to as a driving force distribution display.

### SUMMARY

However, in a case where a four-wheel drive vehicle is driven autonomously, since the vehicle is not operated by the driver himself/herself, there is a high possibility that a display other than the driving force distribution display is desired. Therefore, there has been a demand for a technique for appropriately performing display of a display device in accordance with the respective traveling modes of manual driving and autonomous driving.

The present disclosure can be realized as the following embodiments.

(1) One aspect of the present disclosure relates to a display control device provided in a vehicle in which:
the vehicle
includes an autonomous driving mode or a manual driving mode as a traveling mode, and
includes a display unit that displays information to an occupant; and
the display control device
controls the display unit,
includes a plurality of categories of display modes including a first category of display mode in which a state of the vehicle at a timing of display is displayed and a second category of display mode in which the state of the vehicle at the timing of display is not displayed, and
when a predetermined first condition is satisfied including that the traveling mode is switched from the manual driving mode in which display in the first category of display mode is performed on the display unit, to the autonomous driving mode, performs display in the second category of display mode on the display unit at a timing of display in the autonomous driving mode.

With such a configuration, the display control device of the present disclosure performs display in the second category of display mode at the timing of display in the autonomous driving mode.

In the autonomous driving mode, it is less likely that the occupant is involved in driving, and therefore, it is less likely that the occupant requests the first category of display mode in which the state of the vehicle at the timing of display is displayed. Therefore, the display control device of the present disclosure increases the possibility that the display mode desired by the occupant can be displayed on the display unit in accordance with the traveling mode.

(2) In the display control device according to the above aspect,
the second category of display mode may be a mode in which a statistic of a state of the vehicle before the timing of display is displayed.

With such a configuration, the display control device of the present disclosure performs display in the second category of display mode at the timing of display in the autonomous driving mode. The occupant who does not drive is more likely to desire a statistic representing the state of the vehicle at the timing of display in order to recognize the appropriateness of the driving results by the autonomous driving than the state of the vehicle at the timing of display. For example, the statistic is average fuel consumption, average vehicle speed, or the like. Therefore, with the display control device of the present disclosure, the appropriateness of the driving results by the autonomous driving can be recognized.

(3) In the display control device according to the above aspect,
the vehicle may further include
a plurality of drive wheels as wheels to which a driving force is transmitted, and
a driving force adjusting device that adjusts the driving force of each of the drive wheels; and
the first category of display mode may include a driving force distribution display mode in which the driving force of each of the drive wheels is indicated.

With such a configuration, the display control device of the present disclosure can display the second category of display mode desired by the driver in the autonomous driving mode even when the display control device has the driving force distribution display mode as the first category of display mode.

(4) In the display control device according to the above aspect,
the display control device may further store information on frequency that each display mode of the second category of display mode is displayed in a first predetermined period, and
when the first condition is satisfied, display a display mode with highest displayed frequency among the second category of display modes based on the information on the frequency.

With such a configuration, the display control device of the present disclosure can display a display mode that is highly likely to be desired by the occupant, on the display unit, based on the displayed frequency of the display mode.

(5) In the display control device according to the above aspect,
the display control device may further
store information on time during which each display mode of the second category of display mode is displayed in a first predetermined period, and
when the first condition is satisfied, display a display mode with longest displayed time among the second category of display modes based on the information on the time.

With such a configuration, the display control device of the present disclosure can display a display mode that is highly likely to be desired by the occupant, on the display unit, based on the displayed time of the display mode.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is an explanatory diagram illustrating a configuration of a first embodiment;

FIG. 2 is an explanatory diagram illustrating a display unit;

FIG. 3 is an explanatory diagram illustrating a driving force distribution display mode;

FIG. 4 is an explanatory diagram illustrating an eco-drive indicator display mode;

FIG. 5 is an explanatory diagram illustrating an average fuel consumption display mode;

FIG. 6 is an explanatory diagram showing an average vehicle speed display mode; and

FIG. 7 is a flow chart illustrating a process of displaying in the first embodiment.

### DETAILED DESCRIPTION OF EMBODIMENTS

### A. First Embodiment

### A-1. Configuration of the First Embodiment

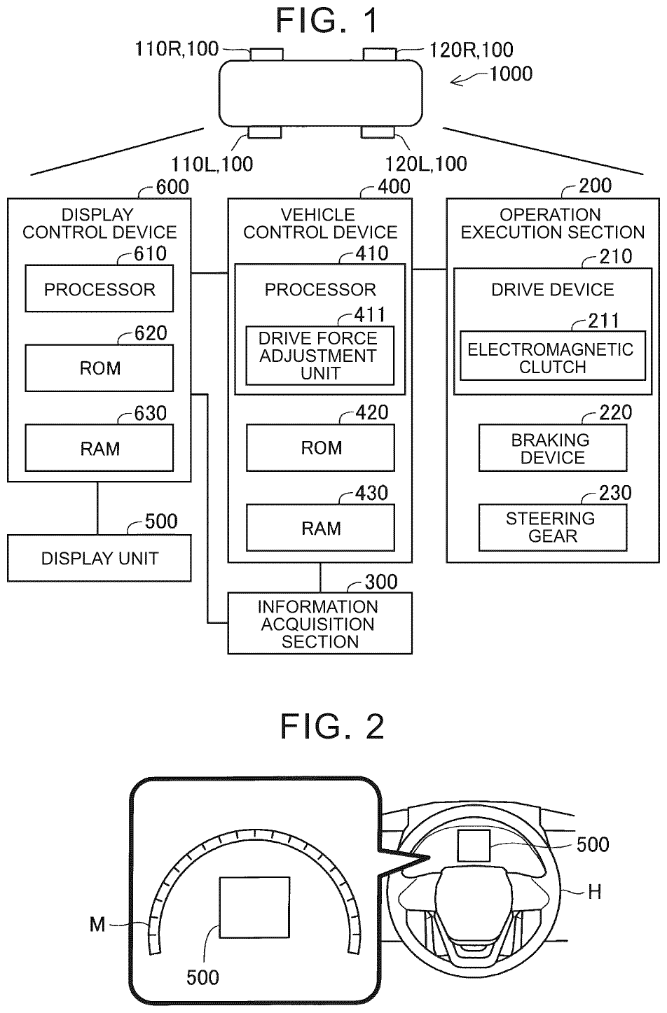

FIG. 1 is an explanatory diagram illustrating a configuration of a first embodiment. The display control device 600 is provided in the vehicle 1000. The vehicle 1000 has an automatic driving mode or a manual driving mode as a driving mode in a state of having a passenger. The driving mode will be described in detail later. Further, the vehicle 1000 is a four-wheel drive vehicle. In the following description, the configuration of the vehicle 1000 will be described before the description of the display control device 600. The vehicle 1000 includes a plurality of drive wheels 100, a driving execution unit 200, an information acquisition unit 300, a vehicle control device 400, and a display unit 500.

The plurality of drive wheels 100 transmit driving force necessary for traveling of the vehicle 1000 to the road surface. That is, the plurality of drive wheels 100 are wheels to which the driving force output by the driving device 210 is transmitted. The plurality of drive wheels 100 includes a front wheel 110R and a front wheel 110L as a pair of wheels disposed on the left and right sides of the vehicle 1000, and a rear wheel 120R and a rear wheel 120L as a pair of wheels disposed on the left and right sides of the vehicle 1000. The plurality of drive wheels 100 are connected to the driving execution unit 200 via an axle or a propeller shaft. In FIG. 1, the illustration related to the structure is omitted in order to facilitate understanding of the technology.

The driving execution unit 200 executes driving of the vehicle 1000. The driving execution unit 200 includes a driving device 210, a braking device 220, and a steering device 230. The driving execution unit 200 is connected to the vehicle control device 400 through a communication line. The driving execution unit 200 executes the driving of the vehicle 1000 using the driving device 210, the braking device 220, and the steering device 230 in response to a command from the vehicle control device 400.

The driving device 210 drives the vehicle 1000. The driving device 210 includes, for example, an engine, a transmission, and a driving force adjusting device. In FIG. 1, the driving device 210 other than the driving force adjusting device is not illustrated in order to facilitate understanding of the technology.

The driving force adjustment device adjusts the driving force of each of the plurality of drive wheels 100. The driving force adjustment device includes, for example, an electromagnetic clutch 211 and a driving force adjustment unit 411. The driving force adjusting device is provided between the front and rear drive wheels 100, between the front wheel 110R and the front wheel 110L, and between the rear wheel 120R and the rear wheel 120L to adjust the driving force of each of the plurality of drive wheels 100. The driving force adjustment unit 411 is a functional unit of the processor 410 in the vehicle control device 400 described later. That is, the driving force adjustment unit 411 adjusts the driving force of each of the plurality of drive wheels 100 by controlling the electromagnetic clutch 211. Information on the distribution amount of the driving force of each of the plurality of drive wheels 100 is sent to the display control device 600. The distribution amount of the driving force will be described in detail later.

The braking device 220 performs braking of the vehicle 1000. For example, the braking device 220 is configured as an electronically controlled braking system.

The steering device 230 performs steering of the vehicle 1000. For example, it is configured as an electric power steering system.

The information acquisition unit 300 acquires information inside or outside the vehicle 1000. For example, the information acquisition unit 300 is various sensors provided in the vehicle 1000 such as an image sensor, a radar sensor, and a yaw rate sensor. Further, the information acquisition unit 300 is a navigation device or an audio device that acquires information via a communication line or a storage medium. The information acquisition unit 300 is connected to the display control device 600 and the vehicle control device 400. The information acquired by the information acquisition unit 300 is sent to the display control device 600 and the vehicle control device 400 through a communication line. Note that the information acquisition unit 300 transmits information irrespective of the control of the vehicle 1000 to only the display control device 600.

The vehicle control device 400 controls the vehicle 1000. The vehicle-control device 400 includes a processor 410, a ROM 420, and a RAM 430. ROM 420 is a read-only semiconductor memory and stores a control program for controlling the vehicle 1000 in advance. RAM 430 is a readable/writable memory, and RAM 430 stores data required for controlling the vehicle 1000. The processor 410 implements various functions by loading and executing a control program stored in a ROM 420 into a RAM 430. The vehicle control device 400 is connected to the display control device 600, the driving execution unit 200, and the information acquisition unit 300 through a communication line.

More specifically, the vehicle control device 400 controls the driving execution unit 200 in accordance with the automatic driving mode and the manual driving mode as the driving mode.

In the manual driving mode, the vehicle control device 400 controls the vehicle 1000 in accordance with the manual driving by the driver. More specifically, the vehicle control device 400 controls the vehicle 1000 by controlling the various driving devices 210 in accordance with the operation of the accelerator, the brake, or the steering wheel H by the driver.

In the automatic driving mode, the vehicle control device 400 controls automatic traveling of the vehicle 1000 to perform automatic driving. More specifically, the vehicle control device 400 controls the driving execution unit 200 by using the detection result by the sensor, the map information by the navigation device, and the like in the information acquisition unit 300.

In the automatic driving mode according to the present embodiment, the vehicle 1000 includes an occupant. However, in the automatic driving mode according to the present embodiment, the vehicle control device 400 is the main driver of the driving. Thus, for example, the state in which both the operation of the accelerator and the brake and the operation of the steering wheel H are partially automated is the manual driving mode in the present embodiment.

Further, the vehicle control device 400 sends the status of the vehicle 1000 to the display control device 600. The situation of the vehicle 1000 is, for example, a driving situation or an external situation. More specifically, the driving situation is the amount of distribution of the driving force to be described later, the magnitude of acceleration and deceleration of the vehicle 1000, and the like. The external situation is a sign, an obstacle, or the like existing around the vehicle 1000 acquired by the information acquisition unit 300. Further, the external situation includes traffic jams and route information received by the navigation device.

FIG. 2 is an explanatory diagram illustrating the display unit 500. The display unit 500 displays information to the passenger. More specifically, the display unit 500 displays a plurality of types of display modes to be described later under the control of the display control device 600. The display unit 500 is, for example, a liquid crystal display. For example, as shown in FIG. 2, the display unit 500 is disposed in front of the driver's seat and below a location where the speedometer M is located. The display unit 500 is connected to the display control device 600.

Next, the display control device 600 shown in FIG. 1 will be described. The display control device 600 controls the display unit 500. The display control device 600 includes a plurality of types of display modes as display modes to be displayed on the display unit 500. The display control device 600 displays one of the display modes of the plurality of types of display modes on the display unit 500. The display control device 600 includes a processor 610, a ROM 620, and a RAM 630. The configurations are the same as those of the processor 410, ROM 420, and RAM 430 in the vehicle-control device 400. The function of the display control device 600 will be described in detail later.

### A-2. Multiple View Modes

The display control device 600 includes a plurality of types of display modes including a first type display mode M10, a second type display mode M20, and a third type display mode.

The first-type display-mode M10 displays the status of the vehicle 1000 at the time of display by the display unit 500. The state of the vehicle 1000 at the time of display is more specifically the state of the latest vehicle 1000 that can be displayed at the time of display. Thus, the first-type display-mode M10 displays the status of the vehicle 1000 in real time. The display control device 600 includes a plurality of display modes as the first-type display mode M10. For example, the first type display mode M10 includes a driving force distribution display mode M11 and an eco-drive indicator display mode M12.

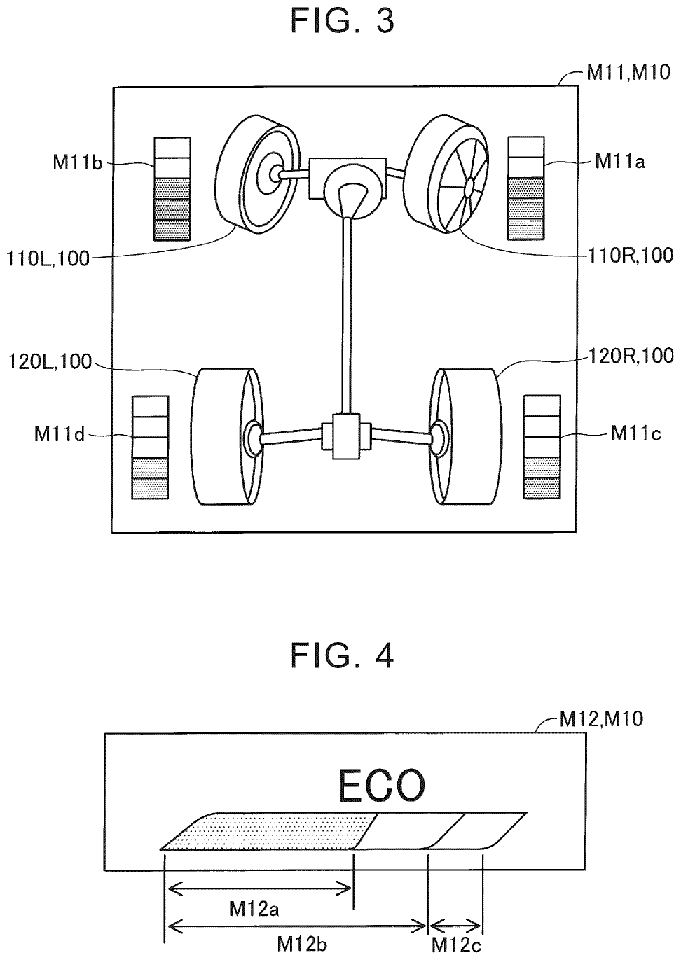

FIG. 3 is an explanatory diagram showing the driving force distribution display mode M11, which is an explanatory diagram showing the driving force distribution display mode M11, showing the driving force of each of the plurality of drive wheels 100. More specifically, the driving force distribution display-mode M11 displays the distribution amounts of the respective driving forces of the front and rear drive wheels 100. As illustrated in FIG. 3, in the driving force distribution display-mode M11, a schematic diagram representing a plurality of drive wheels 100 is displayed. Further, in the driving force distribution display-mode M11, M11d is displayed from the scale M11a corresponding to the distribution amounts of the driving forces of the front wheels 110R and the front wheels 110L as a pair of wheels, and the rear wheels 120R and the rear wheels 120L as a pair of wheels. An increase or decrease in the color scheme of each scale indicates an increase or decrease in the distribution amount of the driving force.

The driving force distribution display-mode M11 represents a distribution amount of the driving force at the time of display by the display unit 500. That is, the driving force distribution display-mode M11 changes the respective scales in real time in accordance with a change in the distribution amount of the driving force.

FIG. 4 is an explanatory diagram illustrating an M12 of an eco-drive indicator displaying mode. The eco-drive indicator display mode M12 shows the assessment of environmentally friendly driving practices. As shown in FIG. 4, the eco-drive indicator display mode M12 has three areas. The eco-drive indicator display mode M12 indicates an evaluation result of environmentally friendly driving by lighting in the respective areas. More specifically, the lighting of the area M12a indicates the accelerator operation amount at the time of displaying. The range M12b is a range of the accelerator operation amount evaluated as an environmentally friendly driving. The range M12c is a range of the accelerator operation amount exceeding the range M12b.

The driving force distribution display mode M11 and the eco-drive indicator display mode M12 transmit the status of the vehicle 1000 to the driver in real time. Therefore, the driver can review the driving method in real time.

The second-type display-mode M20 does not display the status of the vehicle 1000 at the time of display. More specifically, the second-type display-mode M20 displays a statistic of the status of the vehicle 1000 before the display time point. Hereinafter, the average fuel consumption display mode M21 and the average vehicle speed display mode M22 will be exemplified as the display mode in the second type display mode M20.

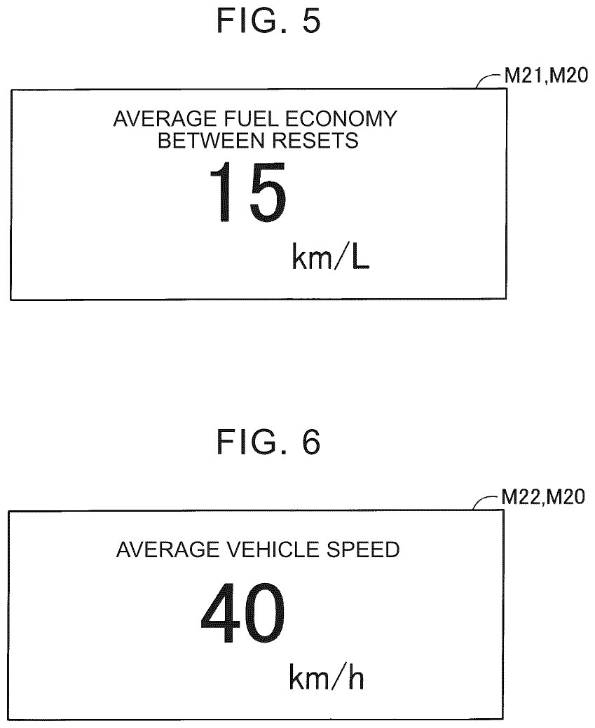

FIG. 5 is an explanatory diagram illustrating an average fuel consumption display mode M21. The average fuel consumption display mode M21 displays the average fuel economy of the vehicle 1000 during a predetermined measurement. The predetermined measurement period is, for example, a period from the time when the switch is turned on by the occupant by providing a switch on the display unit 500 to the present time. The duration of this measurement is also called the time between resets. In FIG. 5, the average fuel consumption in the measurement period of the vehicle 1000 is illustrated as “average fuel consumption between resets”.

FIG. 6 is an explanatory diagram illustrating an average vehicle speed display mode M22. The average vehicle speed display-mode M22 displays the average vehicle speed of the vehicle 1000 during the measurement. The predetermined measurement period is the same as the measurement period in the average fuel consumption display mode M21.

The average fuel consumption display mode M21 and the average vehicle speed display mode M22 transmit a statistic indicating the status of the vehicle 1000 to the occupant. The occupant can comprehensively evaluate the travel of the vehicle 1000 up to the time of display, for example, by checking the statistic.

The third type display mode displays content irrespective of the situation of the vehicle 1000. For example, the third type display mode is a moving image or an image acquired by the information acquisition unit 300 through a communication line.

### A-3. Processing of Display Control Device

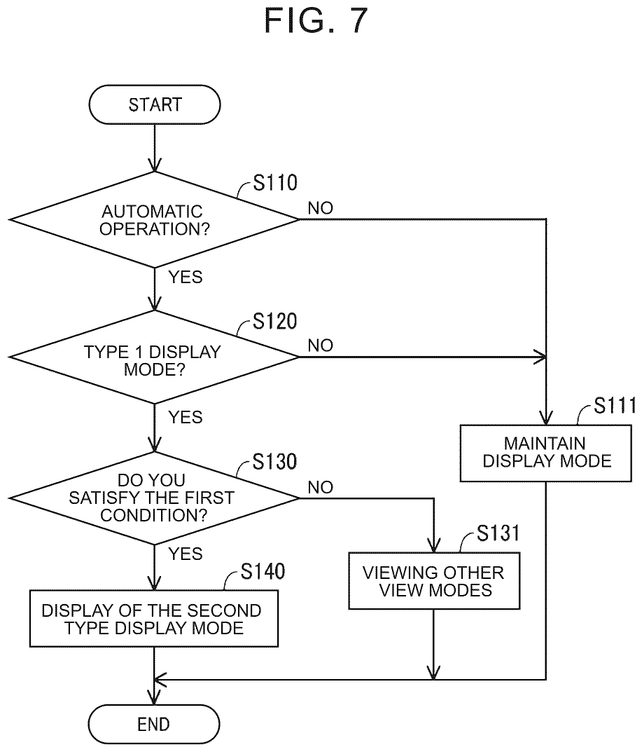

FIG. 7 is a flowchart illustrating a display process according to the first embodiment. The function of the display control device 600 will be described below. The display control device 600 starts processing in response to switching of the traveling mode by the vehicle control device 400.

In S110 of FIG. 7, the display control device 600 confirms the traveling mode. More specifically, the display control device 600 advances the process to S120 when the traveling mode is the autonomous driving mode. The display control device 600 advances the process to S111 when the traveling mode is the manual driving mode.

In S111 of FIG. 7, the display control device 600 maintains the display mode at the time of display of the display unit 500. That is, the display control device 600 does not switch the display mode. After S111 process, the display control device 600 ends the process of this flow chart.

In S120 of FIG. 7, the display control device 600 confirms the display mode at the time of display of the display unit 500 in the autonomous driving mode. More specifically, when the display mode at the time of display of the display unit 500 is the first type display mode M10, the display control device 600 advances the process to S130. When the display mode at the time of display of the display unit 500 is the second type display mode M20, the display control device 600 advances the process to S111.

From S130 of FIG. 7, the display control device 600 performs display by the second-type display-mode M20 on the display unit 500 by S140 process. More specifically, the display control device 600 performs display by the second type display mode M20 when a predetermined first condition including that the driving mode is switched from the manual driving mode in which the display by the first type display mode M10 is performed in the display unit 500 to the automated driving mode is satisfied. This process will be described in detail below.

In S130 of FIG. 7, the display control device 600 confirms the first condition. The first condition includes that the driving mode is switched to the autonomous driving mode. A condition in which the driving mode is switched to the automatic driving mode is referred to as a condition related to the driving mode. In S130, the condition related to the driving mode is satisfied. The first condition includes a condition related to another display mode in addition to the condition related to the traveling mode. Conditions related to other display modes include, for example, a condition under which an instruction to display in the first-type display mode M10 is not issued even in the automated driving mode, a condition under which an instruction to display the third-type display mode is not issued like a moving image distributed through a communication line in the automated driving mode, and the like. That is, the condition related to the other display modes is a condition in which an instruction to display a display mode other than the second type display mode is not given. Therefore, if the first condition is not satisfied, the display control device 600 advances the process to S131. If the first condition is satisfied, the display control device 600 advances the process to S140.

In S131 of FIG. 7, the display control device 600 displays another display mode based on an instruction to display a display mode other than the second type display mode. For example, when an instruction to display in the first-type display mode M10 is issued in the automated driving mode, the display control device 600 displays the first-type display mode M10.

In S140 of FIG. 7, the display control device 600 performs display by the second-type display-mode M20 on the display unit 500. When the second-type display mode M20 includes a plurality of display modes, the display control device 600 displays, for example, a display mode having the highest display frequency among the second-type display mode M20. This frequency is a frequency at which each display mode of the second type display mode M20 is displayed in a predetermined first time interval. The first period is a period in which the automatic driving included within a predetermined time from the present time is performed. For example, the first period is a period from the time of display to one month ago. The frequency is stored in RAM 630 of the display control device 600. Accordingly, when the first condition is satisfied, the display control device 600 displays the display mode having the highest displayed frequency in the second type display mode M20 based on the frequency information displayed in the first period. After S140 process, the display control device 600 ends the process of this flow chart.

With this configuration, the display control device 600 of the present disclosure performs display by the second type display mode M20 at the time of display in the autonomous driving mode. In the autonomous driving mode, since the passenger is unlikely to be involved in driving, the passenger is unlikely to desire a first-type display mode M10 that displays the status of the vehicle at the time of display. Therefore, the display control device 600 of the present disclosure increases the possibility that the display mode desired by the occupant can be displayed on the display unit 500 in accordance with the traveling mode.

Further, the display control device 600 of the present disclosure performs display by the second type display mode M20 at the time of display in the autonomous driving mode. The passenger who does not drive is more likely to desire a statistic representing the state of the vehicle 1000 at the time of display in order to know the appropriateness of the driving result by the automatic driving than the state of the vehicle 1000 at the time of display. For example, the statistic is average fuel consumption, average vehicle speed, or the like. Therefore, the display control device 600 of the present disclosure can know the appropriateness of the driving result by the automatic driving.

Moreover, even when the display control device 600 has the driving force distribution display mode M11 as the first type display mode M10, the second type display mode M20 desired by the driver can be displayed in the automated driving mode.

Furthermore, the display control device 600 of the present disclosure can display a display mode that is highly likely to be desired by the occupant on the display unit 500 based on the displayed frequency of the display mode.

### B. Second Embodiment

In the first embodiment, as the process of S140 in FIG. 7, the display control device 600 displays the display mode having the highest frequency displayed in the second type display mode M20. However, when the first condition is satisfied, the display control device 600 may display the display mode having the longest displayed time in the second type display mode M20 based on the time information. This time is the time at which each display mode of the second type display mode M20 is displayed in a predetermined first time interval. The first period is the same as the first period in the first embodiment.

With such a configuration, the display control device 600 according to the second embodiment can display a display mode that is highly likely to be desired by the occupant on the display unit 500 based on the displayed time of the display mode.

### C. Third Embodiment

In the above embodiment, the first-type display mode M10 displays the status of the vehicle 1000 at the time of display, and the second-type display mode M20 displays the statistic of the status of the vehicle 1000 before the time of display. The display control device 600 according to the third embodiment may further include a fourth type display mode for displaying both the status of the vehicle 1000 at the time of display and the statistic of the status of the vehicle 1000 before the time of display. For example, the fourth type of display mode causes the display unit 500 to display the evaluation result in the eco-drive indicator display mode M12 and the average fuel consumption in the average fuel consumption display mode M21.

The display control device 600 of the third embodiment treats the fourth-type display mode as the first-type display mode M10 or the second-type display mode M20 on the basis of the size of the area displaying the respective information of the state of the vehicle 1000 at the time of display and the statistic of the state of the vehicle 1000 before the time of display. That is, in the process of FIG. 7, the fourth-type display mode is treated as the first-type display mode M10 when the information representing the state of the vehicle 1000 at the time of display is displayed to the greatest extent. Furthermore, the fourth type display mode is treated as the second type display mode M20 when the information representing the statistic of the status of the vehicle 1000 before the display time point is displayed to the greatest extent.

With such a configuration, the display control device 600 according to the third embodiment can display a display mode that is highly likely to be desired by the passenger on the display unit 500 even when the display control device includes a fourth type display mode in which the plurality of types of display modes include the status of the vehicle 1000 at the time of display and the statistic of the status of the vehicle 1000 before the time of display.

### D. Other Embodiments

(1) In the above-described embodiment, the display control device 600 includes, for example, a driving force distribution display mode M11 and an eco-drive indicator display mode M12 as the first type display mode M10. However, the display control device 600 may include one or more display modes as the first type display mode M10. That is, the display control device 600 may be configured to include only the driving force distribution display mode M11 as one type-1 display mode M10. Similarly, for the second-type display mode M20, the display control device 600 may include one or more display modes as the second-type display mode M20. That is, the display control device 600 may be configured to include only the average fuel consumption display mode M21 as one second type display mode M20.

(2) In the above-described embodiment, the second type display-mode M20 displays a statistic of the status of the vehicle before the display time point. The second-type display-mode M20 may be any form that does not display the status of the vehicle 1000 at the time of display. For example, the second-type display-mode M20 may display the status of the vehicle 1000 during a time period that does not include the time point of display. More specifically, a statistic of the situation of the vehicle 1000 in a predetermined period before the time point of display may be displayed. Further, for example, the second-type display-mode M20 may display a predicted status of the vehicle 1000 after the display time point.

(3) In the above embodiment, the plurality of types of display modes may not include the third type of display mode. That is, the plurality of types of display modes may be only the first type display mode M10 and the second type display mode M20.

(4) In the above-described embodiment, the vehicle 1000 can travel by four-wheel driving. However, the vehicle 1000 may be a vehicle capable of only traveling by two-wheel driving. Further, the vehicle 1000 may not include the driving force adjustment device.

(5) In the above-described embodiment, the display control device 600 may be provided in the vehicle control device 400. That is, the display control device 600 may be configured as a part of the vehicle control device 400.

(6) In the above-described embodiment, the autonomous driving mode is a case where the vehicle control device 400 is the main driver of driving. More specifically, the state in which both the operation of the accelerator and the brake and the operation of the steering wheel H are partially automated corresponds to the manual driving mode in this embodiment. However, the state in which both the operation of the accelerator and the brake and the operation of the steering wheel H are partially automated may be an automated driving mode. In this case, in the manual driving mode, either the operation of the accelerator and the brake or the operation of the steering wheel H are partially automated.

(7) In the above-described embodiment, the vehicle 1000 may include a plurality of display units 500. For example, all of the display units 500 may be disposed in front of the driver's seat, or a part of the display units may be disposed in front of the passenger's seat. Note that the display control device 600 performs the processing of the flowchart of FIG. 7 for each of the display units 500 of the plurality of display units 500.

(8) In the above-described embodiment, the first period is not limited to a period from the time of display to one month. The first period of time may be one week prior to the time of presentation. Further, the first period may be a time point of display from a time point based on the operation of the switch by the occupant by providing a switch in the display control device 600.

(9) In the above-described embodiment, the driving force adjustment unit 411 is provided in the processor 410 of the vehicle control device 400. However, the driving force adjustment unit 411 may be configured as an independent control device.

(10) In the above-described embodiment, the display of the statistic in the second type display-mode M20 is a numerical display, but may be displayed by a graph or a marking visually representing the statistic.

(11) In the above-described embodiment, the first condition is a condition including a condition related to another display mode. However, the first condition includes that the driving mode is switched to the autonomous driving mode. That is, the first condition may be only a condition that the traveling mode is switched to the automatic driving mode.

The present disclosure is not limited to the above-described embodiments, and can be realized with various configurations without departing from the spirit thereof. For example, the technical features of the embodiments corresponding to the technical features in the respective embodiments described in the Summary can be appropriately replaced or combined in order to solve some or all of the above-described problems or to achieve some or all of the above-described effects. In addition, if the technical features are not described as essential in the present specification, they can be deleted as appropriate.

What is claimed is:

1. A display control device provided in a vehicle, wherein:
the vehicle
includes an autonomous driving mode or a manual driving mode as a traveling mode, and
includes a display unit that displays information to an occupant; and
the display control device
controls the display unit,
includes a plurality of categories of display modes including a first category of display mode in which a state of the vehicle at a timing of display is displayed and a second category of display mode in which the state of the vehicle at the timing of display is not displayed, and
when a predetermined first condition is satisfied including that the traveling mode is switched from the manual driving mode in which display in the first category of display mode is performed on the display unit, to the autonomous driving mode, performs display in the second category of display mode on the display unit at a timing of display in the autonomous driving mode.

2. The display control device according to claim 1, wherein the second category of display mode is a mode in which a statistic of a state of the vehicle before the timing of display is displayed.

3. The display control device according to claim 2, wherein:
the vehicle further includes
a plurality of drive wheels as wheels to which a driving force is transmitted, and
a driving force adjusting device that adjusts the driving force of each of the drive wheels; and
the first category of display mode includes a driving force distribution display mode in which the driving force of each of the drive wheels is indicated.

4. The display control device according to claim 1, wherein the display control device further
stores information on frequency that each display mode of the second category of display mode is displayed in a first predetermined period, and
when the first condition is satisfied, displays a display mode with highest displayed frequency among the second category of display modes based on the information on the frequency.

5. The display control device according to claim 1, wherein the display control device further
stores information on time during which each display mode of the second category of display mode is displayed in a first predetermined period, and
when the first condition is satisfied, displays a display mode with longest displayed time among the second category of display modes based on the information on the time.
